(19) United States
(12) Patent Application Publication
(10) Pub. No.: US 2005/0059520 A1
(43) Pub. Date: Mar. 17, 2005

(54) Multi-purpose torque converter that can change the torque regardless of the RPM

(76) Inventor: Josef Wodeslavsky, Tenafly, NJ (US)

Correspondence Address: JOSEF WODESLAVSKY, #5 PETER LYNAS CT., TENAFLY, NJ, 07670, US

(21) Appl. No.: 10/663,120

(22) Filed: Sep. 17, 2003

(51) Int. Cl. F16H 47/08

(52) U.S. Cl. 475/59

(57) ABSTRACT

A transmission, a torque converter and a clutch combine interchangeable based on a concept of gears' oil pump built in a frame that resembles automatic transmission planetary carriage. The high and the low pressure sides of said pump can be fully or partially connected or totally blocked by valves, automatic or manually controlled. Each status of said pump determines how much engine torque multiplication will take place and if the clutch engagement or disengagement will occur. This concept can be used as a stand alone clutch only or with a gear box to enhance to a torque converter as well.

### FIELD OF THE INVENTION

These days, all the automatic transmissions are attached to torque converters. These torque converters are made for 2 major purposes; the first one is to act like a clutch. Whereby it will disengage the engine from the transmission while the driver stops the vehicle. The second purpose is to increase the engine torque output in order to save transmissions up steps. By that, the transmission could have less up shifting steps. Therefore, this minimizes the cost of building so many more shifts, transmission unit. However, the torque converter limitations—the torque increase is subject to its RPM. This means that only if the engine has high RPM, would the torque converter have the same.

The aim of this invention is to eliminate the need for the common automatic or even the standard shift transmission altogether. It would be a major cost cut, a weight cut, a maintenance cut, and even a space saver, as well as other stuff saver. The other aim of this invention is to reduce the risk of engine wear. This wear is a result of insufficient lubrication in the engine. Specifically when the engine is very cold and the oil is thick, it is hard for the oil to move through very thin lines in the engine. This is also the case in a wore-down engine with some kind of an oil pressure leak in its internal parts.

### SUMMARY OF THE INVENTION

This new invention will combine the torque converter with the transmission as one unit. This way it will be able to change an increase in the engine torque output at any given RPM.

The ordinary torque converter function is based on internal fins which are located in some kind of a big hollow oil donut. This also consists of a stator, a turbine and a roller clutch. The main idea of that torque converter is that the oil that is being spun by the internal fins gets also a centrifugal force. This force is being used to ‘work’ on the turbine. The turbine rotates the transmission input shaft. The output torque depends on the spin of the engine crank shaft's RPM. Therefore, only at the high RPM, may the torque be increased. Therefore, the common torque converter has this limit. My invention's torque is not linearly dependent on the engine's RPM. This is exactly what the transmission does. Therefore, it can be replaced with my new torque converter. Every transmission has a limit of up shifting steps which depends on how many gears it has. Between each up shifting the engine rests a little bit. If one will press the gas peddle hard, the transmission will not up shift, and the engine RPM will overrun. This is one big limitation. My product will offer a completely different attitude whereby the up shifting will be under load of the wheels on the engine with no engine rest.

My invention will also overcome the existing draw back that the torque is subject to its RPM. It will be able to produce and multiply the engine torque at even very low engine RPM. Even at engine idling. Also, my invention will be able to produce a huge torque at the very high RPM, or small one, at very high RPM, a lot more than the conventional one. This system will be a lot more flexible than current systems. Many vehicle manufacturers are trying to eliminate the transmission by inserting some kind of a variator system instead of the transmission. Such variators are being used in many other industries for many years. The uses are for: changing machine speed with respect to the electric motor speed. This variator system uses some kind of a belt that transmits the engine power to the wheels. The problem that they are facing is that they still need some kind of a clutch, and the belt has a limit of a torque that can get through it. After a certain point, the belt will tear apart from excessive engine torque. The novelty of this invention is to use a common oil pump as a part of this torque converter by opening and closing the high side of that pump to the low side of it. By doing that, we get less or more gear ratios. We are using this pump to get an effect of breaks in order to achieve this mission.

The other outcome of my invention is that this new torque converter will replace the need of a transmission. Also, the aim of this invention is to minimize the friction of the engine parts which are not getting sufficient lubrication at the time of freezing when the engine is started and the engine is not warm enough. Since it takes too much time for the oil to get to the internal parts. This oil will not get also to my new torque converter. So my torque converter will not allow the placing of a load on an engine which is not ready for that load since it is not lubricated. My new torque converter will keep the engine disengaged from the wheels until enough oil pressure is built up.

### A BRIEF DESCRIPTION OF THE DRAWING

FIG. 1 will illustrate the torque converter being used for clutch only from a side cut view.

FIG. 2 will illustrate the torque converter being used for clutch only from a face cut view.

FIG. 3 will illustrate the torque converter with automatic clutch engagement.

FIG. 4 will illustrate the torque converter that can replace transmission.

### DETAILED DESCRIPTION OF THE DRAWING

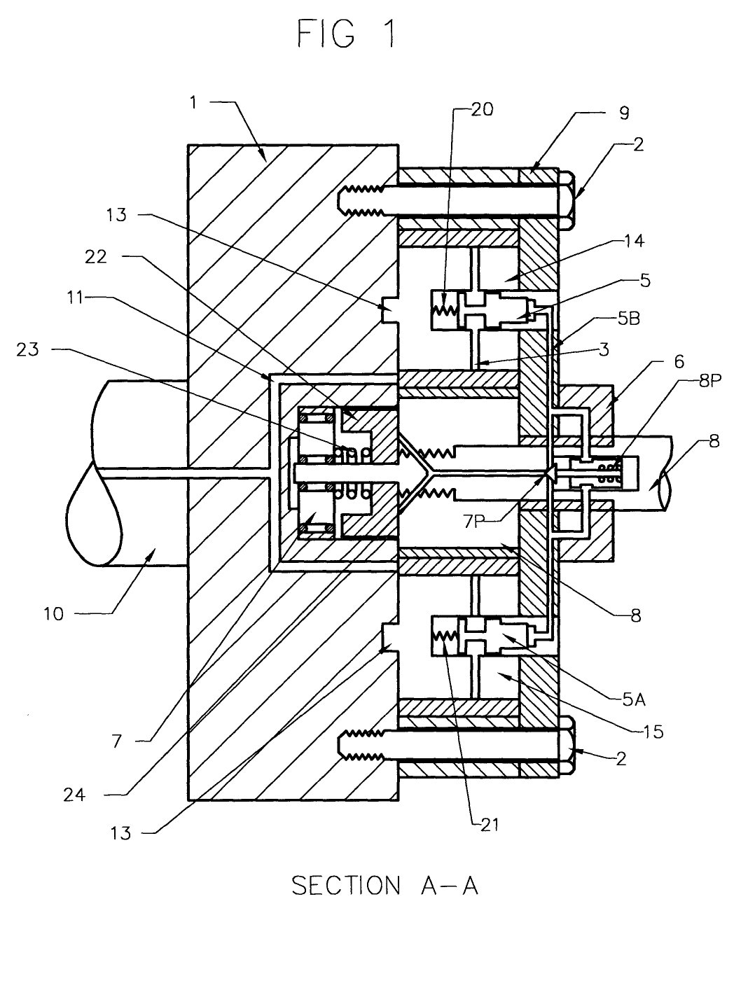

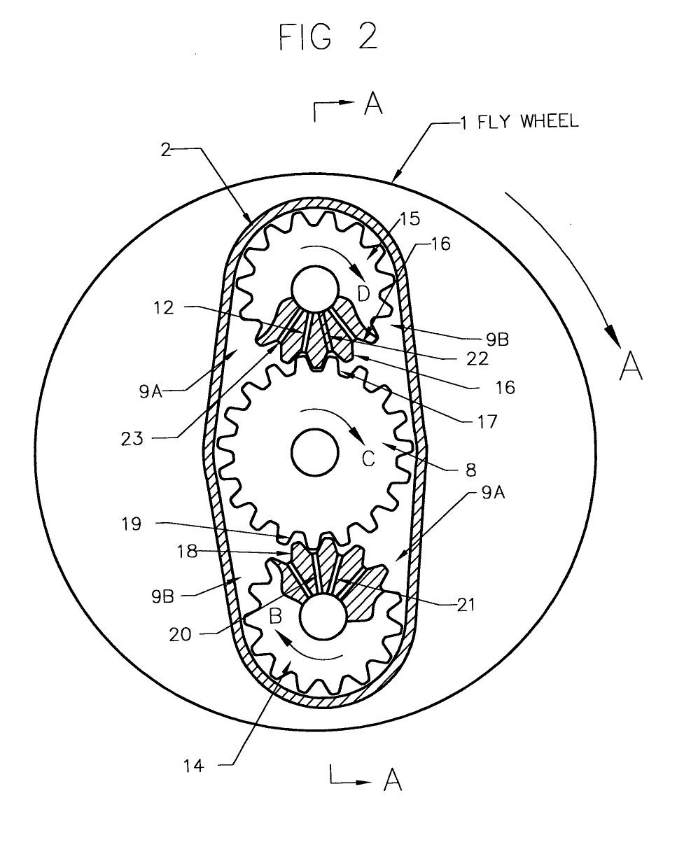

FIG. 1 and 2 are illustrating the torque converter embodiment from the side view and the face view.

Looking at the side view, the crank shaft 10 is connected to the flywheel 1. This new method of torque transmission functions as follows:

Once the engine is started, the crank shaft 10 is rotating the fly wheel 1. The fly wheel will rotate the bearing 13 which will take the gears 14 and 15 with it. If there is no oil in inlets 9a (look at FIG. 2) the satellite gears 14 and 15 will rotate surrounding the main drive sun gear 8 and the gear 8 will stand still. The oil pressure will get from the crank shaft into inlets 9a, it will continue to the outlet 9b. It happens because those gears will rotate around the pin 13. This apparatus will act like an oil pump. A pressure will be built up among the gears teethes 16 and 17 and teethes 18 and 19. If this pressure will not have where to drain, this pressure will create hydraulic lock. Therefore it will not let the gears 14 and 15 rotate surrounding the gear 8. Therefore it will turn the complete setup to be seized. Therefore the flywheel will turn to one unit with the gear 8 which will start to rotate with the flywheel. This will put a torque on the main drive.

(Look at FIG. 1) In the beginning, if the engine is rotating in idling, the governor 6 will not let oil go out. The springs 20 and 21 will hold the selector pins 5 and 5a in position to connect and make communication between the teethes' bores 20, 21 and 22, 23 (FIG. 2) and among them. All the oil that will get to the outlets 9b will be drained to the inlets 9a. No hydraulic lock occurs. A description of one method of this transmission's function is hereby given.

Once the engine will rotate in higher RPM, the amount of oil that will get to the outlets 9b will not be able to drain out via the teethes bores. Since some of the oil will remain among those teethes, it will create partial hydraulic lock. The gears 14 and 15 will necessarily partial lock. The fly wheel will start rotating the center gear 8 which will rotate the main drive. This will start to move the vehicle to a certain speed. The governor is connected to the main drive gear 8. Since the main drive gear 8 is rotating and has an oil feeding from the engine oil pressure side, this governor will open selector pin valves 5 and 5a. The governor will send oil pressure to the selector pins 5 and 5a's upper surface. These selector pins 5 and 5a will start moving against springs 20 and 21. By so moving, the oil flow from the outlets 9b to the inlets 9a will be reduced. This will cause more oil to stay at outlets 9b. This will cause an even greater hydraulic lock to be created. Therefore, the flywheel will cause the main gear to turn even more. As the governor senses a higher rotation speed, it will continue to send more pressure to the selector pins' surface which will eventually close the oil passage between the inlet and the outlet of said pumps. This will create a full hydraulic lock between those gears and seize them. Therefore the flywheel's speed will be equal to the output of the main gear. It should be noted that as long as the satellite gears are rotating the sun gear, the engine torque will be increased upon the gear ratio between the satellite gear diameter and the sun gear diameter.

Once the engine's RPM is equal to the governor's speed, the governor will send oil pressure directly or via the selector pin to the one way clutch 7, hydraulically activating it via passage 7p. This will lock the fly wheel to the main gear 8. Therefore the torque from the engine will go directly with a mechanical engagement between the gear 8 and the fly wheel 1.

Once the load on the vehicle will be increased, the governor or a vacuum modulator will reduce the pressure to the one way clutch activator so the one way clutch will be disengaged. The fly wheel would continue to transmit the power via the hydraulic method as described before.

It should be noted that a computerized system such as being used in automatic transmissions in vehicles can be applied to control the governor or an electronically control panel can replace the governor altogether whereby electric solenoid will replace it to open or close a pressure line to those selector pins. Such electric solenoid systems are notorious for now many years in automatic transmissions. It should be noted that it could be that some kind of interrupted switch should be introduced to the system of the engine disengagement. This will be described late.

Comparable to un-tying a rope; One must release the pressure on the rope in order to untie it. Similarly, the engine must be shut off for a short time (a second). This is needed so that the engine will not create a torque on the one way clutch. During this ‘neutral’ intermission, the one way clutch releases.

Also, the one way clutch (sprug) disengagement will take place in parallel to the engine ignition or fuel cutoff momentarily in order to make sure that the engine torque will snap for a minimum set of time in order to stop the torque on the one way clutch while this engagement is still taking place, in order to reduce the engine's RPM that will be reduced relative to gear 8 rotations which will make the one way clutch release from the engine mechanical force.

A second method of the transmission engagement via my new system will here be described.

The size of the oil bore that supplies the oil to the pump in my torque converter from the crank shaft can be calculated. All the oil that will reach that pump always will be drained from those perforated teethes system in any given RPM that said pump will be exposed to. The pressure build up among those teethes will occur only if those selector pins will start to block those perforated holes. As long as the transmission shifter that the driver is using will be in neutral, those selector pins will let the oil go from the high side to the low side of that pump. Only once the driver will put in forward or reverse, he will make the selector pins partially block those bores. This will start moving the car forwards or backwards. The rest will occur as described already before. The governor would do the rest.

An oil check valve can be placed at the crank shaft oil pressure feeding, in order to keep this torque converter assembly full with oil while the engine is off. This is so that the oil will be blocked of from going back to the engine.

In order to control the oil supply to the pump, this check valve can be controlled by the driver manually or automatically. This method will control the oil supply to the torque converter. If the oil is going there, the torque converter will transmit power to the transmission, and if not, the vehicle will not move. There is also another method to have the vehicle in neutral or in moving mode.

This new method of torque transmission can be used as a clutch only between ordinary gear shift transmissions as well. This will be described here after.

The selector pins 5 and 5a will be pushed in by an ordinary notorious throat bearing in order to open the pressure to go to the inlet side. This is in order to let the satellite gear rotate around the sun gear 8, once the clutch pedal will be pushed in order to disengage the engine.

It should be noted that the oil supply from the crank shaft can be replaced by an oil tank that can be part of the flywheel. This fly wheel will be partially hollow to contain the oil.

An independent oil pump to create the oil pressure to replace the engine oil pressure can be adapted the same way that it is being done in an ordinary transmission. Also, since the selector pins inside movement does not create any resistance compared to an ordinary clutch pressure plate springs, therefore, other methods to push or to pull those pins can be used something like an electromagnet being used in the clutch assembly of an air condition compressor with its pulley. This electromagnetic assembly can be placed on a sleeve which is a part of the regular transmission which is being used. Normally the throat bearing is being placed on this sleeve. Such an electromagnet can be affixed to that transmission unit. By supplying electric power to said electromagnet, the electromagnet will pull or push those selector pins. This electric method can be activated by the handle shifter and not necessarily by a clutch pedal. There is an old known method already for many years. The V.W. beetles used to have such a clutch disengagement method. This method is based on the notion that once the driver wants to put the handle in forward or backwards gears, this handle will make an electric contact via an electric switch. This handle will consist of an electric switch. By moving this handle first, an electromagnet will get electric power. This will, in return, push or pull the above selector pins which are in the perforated gears. The above satellites will stop turning the sun gear. The engine transmission disengagement will occur.

Another method of using this new clutch is to eliminate the selector pins and their control altogether. This method will be described below.

FIG. 2 will illustrate a cut view of a flywheel 1 that consists of a pump 2, a sun gear 8, satellite gears 14 and 15.

The diameter of the bores in the satellite perforated gears will be designed so that the oil that would get there, in engine idling speed would be drained from the pressure side of the gears 9b to the inlet side 9a of those gears. Once the engine RPM would be increased, the amount of oil that would get to the pressure side would be too much to be drained through those bores. The pressure and therefore the hydraulic lock will increase. Therefore, the satellite gears will start to get stuck. These satellite gears would start to rotate the sun gear.

As the RPM increases, the amount of oil that will get between the satellite gear and the sun gear locking side would be sufficient to lock the satellite gears to the sun gear. This will cause the satellite and the sun gears to seize. This will consequentially make the fly wheel turn the sun gear directly. At this method, the satellite gear will continue to rotate surrounding the sun gear. During this sun gear rotation the outcome will be that always new oil must come into between those gears. This will cool this complete apparatus by new oil which is circulated and maybe cooled by oil cooler. This method may be used for heavy duty trucks where the load on the oil could be too harsh.

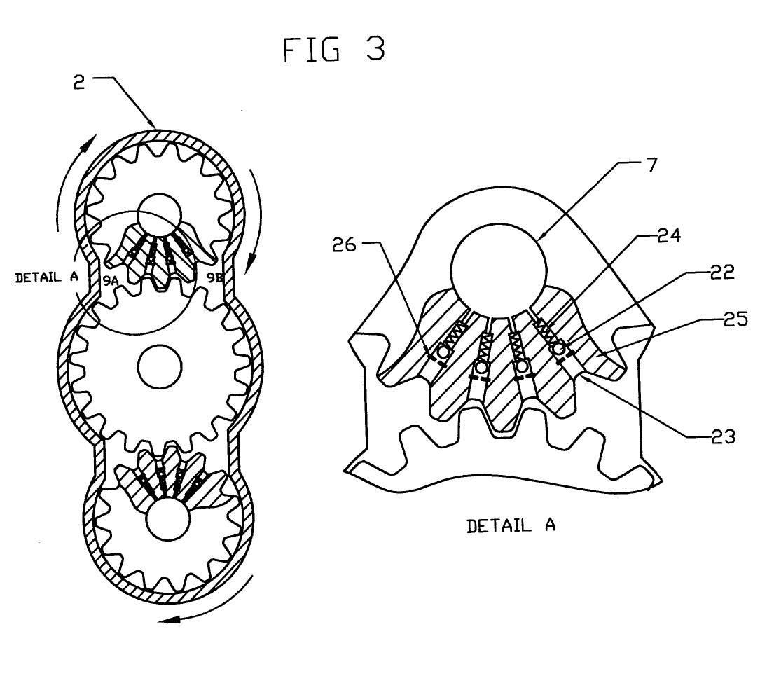

FIG. 3 will illustrate another method to stop the oil from being drained from the satellite gears and the sun gear locking side at certain RPM. This method is to put a one way valve 22 into the bores 23. These bores are running between the teethes root diameter 6 and the cylinder 7. This cylinder is in the center of the satellite gears. This is in order to lock the oil after certain RPM. This one way valve 22 would be kept open by a spring 24 at idling RPM. Therefore, the satellite gears would not rotate the sun gear. Once the RPM is increased, and the one way valve is facing the sun gear, the centrifugal force which is applied to that valve would push it to closed position. This will occur at a certain given RPM only. This is in order to lock the oil in between the satellite gears and the sun gear at a certain RPM. This will, in effect seize the satellite gears to the sun gear. This will make the fly wheel drive the sun gear.

Another way to control the oil pressure (which will control the sun gear rotation) is to control the crank shaft oil supply to the inlet side of this pump. If that oil supply will be cut and only enough to lubricate the gear will be left, this clutch assembly will run on neutral. Since there is a need for oil in order to have that pump functioning.

This embodiment also can consist of a roller one way clutch. This clutch will lock only if the wheels will turn faster than the engine. It is important because it can be used for trucks whereby the engine will be used for breaking or stopping the truck in sloped-down heels.

This one way clutch can be used the other way around. It can be applied to lock the engine to the wheels with hydraulic activator once the engine runs at the same speed as the sun gear. In such a case all the power will be transmitted mechanically/physically directly and not via this hydraulic mechanism.

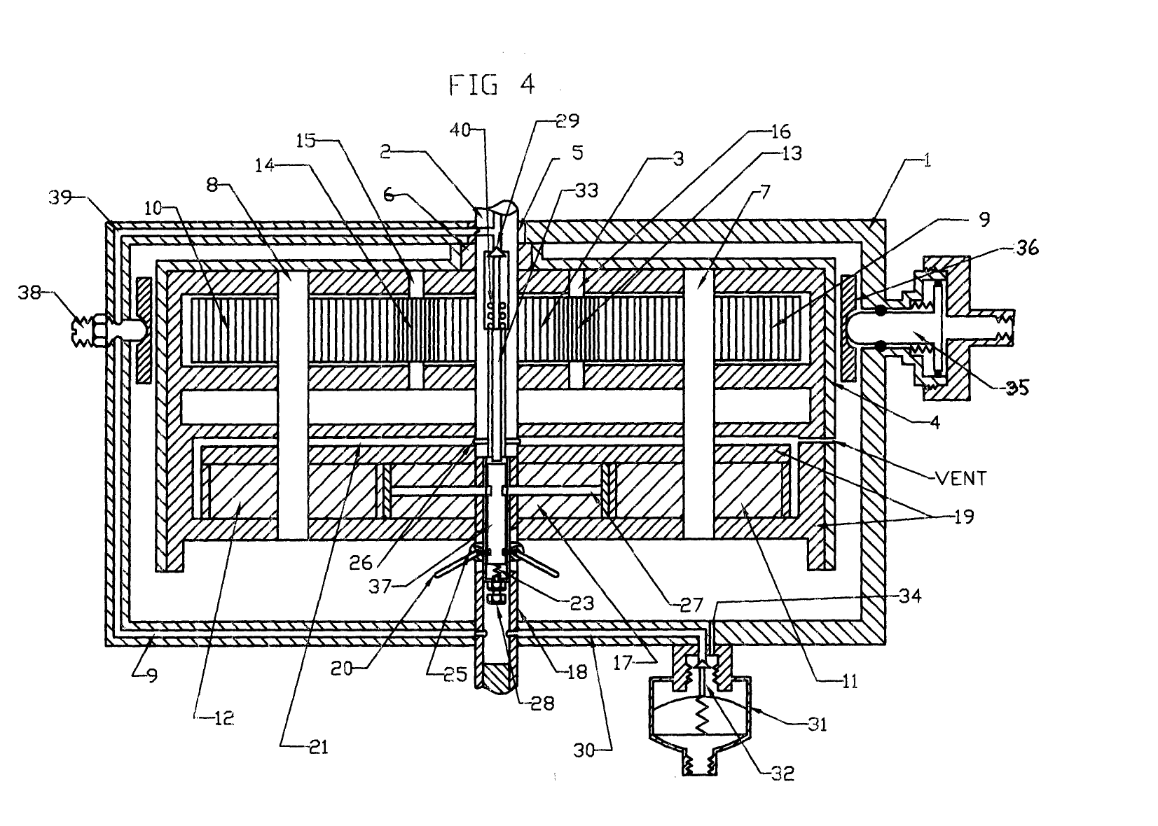

FIG. 4 will illustrate: a transmission housing 1, a crank shaft 2 which rotates sun gear 3, crank shaft 2 is housed in a slideable position in a carriage 4. Carriage 4 consists on the left side of a sleeve 5 that can rotate in the transmission-housing's bushing 6.

Carriage 4 consists of 2 bearings 7 and 8 which in to house two satellite gears 9 and 10. Gears 9 and 10 are connected to gears 11 and 12 respectfully.

In between the sun gear 3 and the satellite gears 9 and 10 are mounted intermediate satellite gears 13 and 14 which are also mounted in carriage 4. To output shaft 18 is mounted the centrifugal activated governor 25, which consists of a plunger 37 that can control the bores 27 in its cylinder (this cylinder is in perforated gear 17). The weights 20 will move and control this plunger upwards against spring 23 which is controlled by adjustable screw 28. This is in order to control the up and down transmission shifting. This plunger can reduce the size of the bores which are in the cylinder of the perforated gear 17, subject to the rotation speed of the output shaft until it can be totally closed. It should be noted that this method will control the torque decrement of this new torque converter. This will take place upon the load on the output shaft. This governor is only one given method for example only in order to change the control of the engine torque. All the existing methods that already exist in automatic transmissions nowadays to control the up and down transmission shifting can be adapted to control my system as well.

Gears 11 and 12 are forming an oil pump 19 along with gear 17 in the center. Such pump was described in the previous FIG. 1.

This apparatus functions in the following manner: Once the engine starts to run, the engine oil pressure will get from the crank shaft 2 to passage 6. This pressure will get to the other side of this apparatus and will get to the output shaft 18. At this shaft is located a selector pin.1 This pin is controlled by the spring force 23 of the centrifugal governor 20. This pressure will push pin 33. This will lock valve 29 to its seat into a closed position. Therefore, no oil pressure will get to tunnel 21 to feed the inlet of the oil pump. It should be noted that only a tiny bit of oil will get to that oil pump in order to lubricate that pump. The unit will be kept in neutral since we do not have any hydraulic lock between the gears of the oil pump.

Once the driver will put the gear stick into ‘Drive’, he will release the mechanism that holds pin 33 in lock position (Mechanism is not shown). The moment the driver will apply pressure to the gas pedal two events will transpire: 1) The throttle valve body or the fuel computer will get a signal and 2) The transmission low oil pressure system will get a signal (This is a knows method being used in automatic transmissions). Hence, the gas pedal will pull the valve 32 from its seat. This will result in oil pressure drop on the selector pin 37. This will release the pressure from pin 33. Consequently, the oil pressure on the governor will drop via passage 34. This pressure drop will let the oil pressure from the engine overcome the resistance of the spring 40. The oil pressure will open valve 29 and push a little bit pin 33 and selector pin 37 against spring 23. This will be done in order to close a bit the passage of bores 27 in the perforated gear 17. This will result in hydraulic lock at the oil pump. This will eventually try to move the car. Once this car will start moving, the governor will release the force off of pin 33. Once there is less force on the pin 33, valve 29 will open up so that more oil will be able to enter the chamber where gears 11 and 12 are. The position of the gas pedal will control the oil pressure that controls the governor position. This will determine the up and down gear shifting relative to the engine load.

Once the driver will change the gear to ‘Reverse’, he will open a selector to transmit oil to piston 35. This will close the reverse band 36 to lock carriage 4, make the internal satellite gears rotate the gear 17 in the reverse direction.

Once the crank shaft 2 starts rotating the gear 3 clockwise, gear 3 will rotate the intermediate gears 13 and 14 counter clockwise. Gears 13 and 14 will rotate gears 9 and 10 clockwise. Gears 9 and 10 are connected to gears 11 and 12 via shafts 7 and 8. Therefore, gears 11 and 12 will also rotate clockwise. Gears 11 and 12 are engaged to gear 17. Shafts 7 and 8 are mounted in carriage 4.

If gear 17 will stand still and crank shaft 2 will start to rotate, eventually, gears 11 and 12 will start to rotate and to climb on gear 17 without moving it.

For example: If the ratio between the satellite gears 9 and 10 to the sun gear 3 is 1 to 10 (This means that the 10 rotations of the sun gear 3 will rotate gears 9 and 10 only 1 complete turn). We therefore have a torque multiplication of 10 to 1. Since gears 11 and 12 are connected to gears 9 and 10, and since gears 9 and 10, they will also get rotation of 1 to 10 with torque 10 to 1.

In the beginging, the rotation of the satellites on the gears 17 will make the carriage ‘follow’ the satellites' rotation. Once the satellites will get stuck, the force of the complete complex movement, will transform into the carriage rotation.

Once the carriage and the satellite will go clockwise, if gear 17 will resist rotation (being connected to the wheels) it will result in causing gears 11 and 12 to start rotating surrounding this gear 17. This will cause carriage 4 to rotate with it (This is also in a 1:10 ratio).

If the oil will start partially locking gears 11 and 12 (as described in previous FIG. 1), a clockwize rotation of gear 17 will start to occur (in ratio 1 to 10).

Two forces will act now on gear 17:

Force one is a radial force that comes from the rotation of carriage 4 and its gripped gears. The satellite gears 11 and 12 are a little gripped. Similar to a rubber tire on the road, whereby, while breaking, the tire is trying to grip the road and take the road with it, so too, our satellite gears in the oil pump. If oil is present among the gears, the satellite gears will break on the sun gear but the carriage will continue to push forward.

Consequentially, the satellite gears will ‘take’ the sun gear with them, while they hardly rotate on it. As a consequence, the non-rolling movement of the gears 11 and 12 in radial directions relative to the center of gear 17 are creating a force on the teethes to push the teethes of those gears acting to rotate gear 17. This torque is at a ratio of 1:10 relative to the crank torque.

The secons force is the rotation of the gears 11 and 12 relative to gear 17 which is climbing on it, and is trying to rotate it the other way arround, which makes the carriage 4 go forward.

As long as gears 11 and 12 will rotate surrounding gear 17 and also relative to it, the multiplication of the engine torque will be reduced relative to the reduction speed of gears 11 and 12 on gear 17. Once the rolling stops, the input torque and the output torque will be equal.

Any addition of locking between gears 11 and 12 and gear 7 will cause less rolling of those gears relative to each other which will also cause less rotation between gear 3 and gears 9 and 10. This will result in less torque being transferred between them. Consequesntially, this will cause higher speed of the carriage 4 relative to gear 3. The stronger the hydraulic lock between gears 11 and 12 to gear 17, the greater is the rotation speed of the carriage 4 until all the torque difference is gone.

(All the hydraulic locking system that was described in FIG. 1 will be applied to this figure as well)

It should be noted that the intermediate gears can be eliminated and the rotation of the output shaft will be to the counter clockwise subject to the rotation of gear 3.

Also, it should be noted that the high oil pressure in the pump can be reduced to the low pressure side via other technique like perforated satellite gears at said pump instead of perforating the sun gear.

Also, another method to reduce the high pressure at the pump from the high side to the low side is to put some kind of a valve that will be connected to the system. The pressure will be reduced from the high side of the oil pump via such valve. The governor will control this valve directly. With such a method, no gear perforation is needed.

The other method that can be used to get the same concept is to use a chain to connect the crank shaft input gear to the satellite gears via one or 2 chains or more to drive those satellite gears.

This embodiment can rotate to the reverse direction as well, in order to let the driver, drive in reverse. This mission will be accomplished by adapting a notorious clamp which is currently used in vehicles today in normal automatic transmission. This clamp should block the rotation of carriage 4 to stop such rotation. By doing this, the gears 11 and 12 will be forced to rotate gear 17 to the reverse relative direction of the input gear. Also, a parking mechanism can be adapted to that carriage similarly to what is being used in regular automatic transmission.

1. A clutch and torque converter assembly which consists of an oil pump that is rotating by a torque energy source; Wherein said pump consists of:
A driven gear, defined as a sun gear;
At least one drive gear defined as a satellite gear;
A housing to contain said gears;
An oil inlet side and an oil outlet side, hereby defined as the high and low sides;
An oil passage and blocking means to control oil drainage from said high to low sides;
An axel to pivot satellite gear, freeze connected to said pump;
Wherein said oil passage and blocking means control the motion and speed of the rotation of said gears relative to each other;
Wherein said pump and satellite gear are driven by torque energy source; and
Said sun gear is the torque output-connected to a car wheel for example; and
Said satellite gear and pump rotate around said sun gear;
Wherein said sun gear can be in at least three different modes:
a) Sun Gear Freeze Mode:
The sun gear is not rotating about its own axel;
Said satellite gear is rotating about its own axel;
Sun gear RPM is zero;
Oil pressure is equal at the high and low sides;
Oil is being fully-drained from the high side to the low side;
b) Sun Gear Full-Motion Mode:
The sun gear is rotating about its own axel;
Said satellite gear is not rotating about its own axel;
Sun gear RPM is equal to the pump and satellite-gear-axel RPM;
Oil pressure is higher at the high side than at the low side;
Oil is being fully-blocked from draining from the high side to the low side;
c) Sun Gear Semi-Motion Mode:
The sun gear is rotating about its own axel;
Said satellite gear is rotating about its own axel;
Sun gear RPM is lower than the pump and satellite-gear-axel RPM;
Oil pressure is higher at the high side than at the low side;
Oil is being semi-blocked from draining from the high side to the low side;
Wherein said oil passage and blocking means controls the pressure difference between said high and low sides, so that when there is no pressure difference, the sun gear is in Freeze-Mode; and
When the oil passage is fully blocked, pressure difference builds up to the maximum, resulting in the sun gear's Full-Motion-Mode; and
When only some oil passage is allowed, only some pressure difference builds up between the said high and low sides, producing the sun gear's Semi-Motion-Mode.

2. A torque converter assembly as in claim 1 that further consists of:
A transmission housing to consist said torque converter,
A gear box that consists of a carriage,
An input shaft,
An input gear,
At least one gear being in touch with the input gear, hereby defined as ‘first satellite gear’,
An oil pump housing,
A perforated driven gear disposed in the center of said pump hereby defined as a ‘sun gear’,
And blocking means to control the oil pressure at the high side and the low side of said pump, and
At least one drive gear, disposed in said pump, hereby defined as a ‘second satellite gear’,
A shaft to connect first and second satellite gears, and
An output shaft which has contact with said second satellite gear which is driven by said first satellite gear which is driven by said input gear;
Whereby if said input shaft and said input gear will rotate clockwise, it will rotate the first satellite gear, counterclockwise;
And said first satellite gear is connected to said second satellite gear in a way that said first satellite gear will rotate the second satellite gear together;
And said second satellite gear will rotate said sun gear in said pump, to have selective communications with said sun gear in a way that the first communication would be to roll on said sun gear;
And the second is to be affixed to it and third is partially roll on it and partially affix it together.

3. A clutch and torque converter assembly as in claim 2
Whereby the means to control the high oil pressure between the driven sun gear side and the second satellite gear are mounted in said second satellite gear.

4. A clutch and torque converter assembly as in claim 2
Further consists of intermediate gears between the drive gear and the first satellite gears in order to change the rotation direction of said first satellite gear.

5. A clutch and torque converter assembly as in claim 2
Whereby said second satellite gear consists a cylindrical boar in the center of said gear and said gear is perforated in a way that between each of those gears teeth at its root diameter there is an oil passage that runs from that root diameter to the wall surface of said cylinder whereby whenever said cylinder is not blocked by said blocking means all said boars can communicate via oil connection

6. A clutch and torque converter assembly as in claim 5
Whereby said sun gear consists of a cylinder in its center and bores from its root diameter to the center of said sun gear cylinder and
Said sun gears' cylinder in the center consists of a means to control the size of the exposure of said bores,

7. A clutch and torque converter assembly as in claim 2
Whereby the communication between first satellite gear and the input gear are made via at least one chain.

8. A clutch and torque converter assembly as in claim 6
Whereby the means to control the size of the exposure of said bores are:
A selector type pins that are controlled by means that are controlled automatically by a transmission shifting governor, or a computer, or a clutch pedal, manually activated by the vehicle driver

9. A clutch and torque converter assembly as in claim 6;
whereby said blocking means are selector type of pins that are positioned in said perforated gear's cylinder in order to make selective communication between the boars in said cylinder in a way that if said selector pin covers said boars the communication between the boars will be cut and vice versa.

10. A clutch and torque converter assembly as in claim 1;
Whereby said blocking means are one way valves that disposed in said boars which is in said perforated gear and said one way valves are kept open to allow oil passage between the oil outlet of said pump to the oil inlet of said pump via the boars which are in said cylinder which is disposed in said perforated gears
And said one way valves will reduce the passage of said bores or close it upon the centrifugal force that acts on said one way valve means upon the RPM rotation of said pump and upon the position of said satellite gear relative to said sun gear
In order to let no oil pressure to be build up in said pump in low given revolutions of said pump and
To let oil pressure to be build up at the higher given RPM at said oil outlet of said pump in order to lock said pump to said sun gear in a way to freeze the gears one to the other in order to rotate the sun gear with said pump.

11. A clutch and torque converter assembly as in claim 2;
whereby said blocking means are one way valves that disposed in said boars which is in said perforated gear and said one way valves are kept open to allow oil passage between the oil outlet of said pump to the oil inlet of said pump via the boars which are in said cylinder which is disposed in said perforated gears
And said one way valves will reduce the passage of said bores or close it upon the centrifugal force that acts on said one way valve means upon the RPM rotation of said pump and upon the position of said satellite gear relative to said sun gear In order to let no oil pressure to be build up in said pump in low given revolutions of said pump and
To let oil pressure to be build up at the higher given RPM at said oil outlet of said pump in order to lock said pump to said sun gear in a way to freeze the gears one to the other in order to rotate the sun gear with said pump.

12. A motor that consists of a clutch and torque converter based on claim 2;
That consists of a crank shaft which is connected to a fly wheel and onto said fly wheel is mounted on an oil pump housing which consists of an oil inlet side and oil outlet side
And to said pump is anchored at least one axel to be a pivot for an oil pump gear which is forming a satellite gear and one sun gear which is housed in the center of said pump relative to the crank shaft whereby the satellite gear can rotate surrounding said sun gear and also said satellite gear can rotate on its pivot pin
And in the center of one of the gears there is a boar to form a cylinder
And said satellite cylinders gear is perforated in a way that all the root diameter teeth are connected via oil passages among all those teeth whereby all the oil pressure build up at the pressure side of said pump can be reduced to the inlet side of said pump subject to a given RPM of said motor
And an oil pressure control means dispose in said perforated gear to reduce or to increase the pressure at the pressure side of said pump in order to block the rotation of said pump relative to said sun gear
And said pressure control means are influenced by the sun gear rotation speed output to the effect that the higher RPM of said sun gear gets, the more pressure build up in said pressure side of said pump in order to create stronger grip between said satellite and said sun gear, in order to equalize the motor torque input to said sun gear torque output.

13. A clutch and torque converter assembly as in claim 12;
Whereby the perforated gear is the sun gear instead of the satellite gear.

14. A clutch and torque converter assembly as in claim 1;
Whereby an electric activated means will be deployed in order to close or open the oil movement between the high and the low pressure side of said pump

15. A clutch and torque converter assembly as in claim 7;
Whereby an electric activated means will be deployed in order to close or open the oil movement between the high and the low pressure side of said pump

16. A clutch and torque converter assembly as in claim 2;
Whereby said torque converter assembly consists of a means to block the rotation of said carriage relative to said transmission housing and to anchor the pivot pin of said second satellite gear relative to said transmission housing in order to induce said second satellite gear to rotate the sun gear into reverse direction relative to said input shaft.

17. A clutch and torque converter assembly as in claim 2;
Further consisting of an independent oil pump;
A one way roller clutch;
Whereby said independent clutch will be installed on said transmission housing and be driven by said main input shaft;
And said one way roller clutch will be installed between said input shaft and said torque source;
Whereby the inner racer of said one way clutch will be mounted on said input shaft and said outside racer will be mounted on said input source;
